(19) United States
(12) Patent Application Publication
(10) Pub. No.: US 2004/0145998 A1
(43) Pub. Date: Jul. 29, 2004

(54) Optical head device

(75) Inventor: Hiroshi Kubota, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/727,107

(22) Filed: Dec. 2, 2003

(30) Foreign Application Priority Data
Dec. 11, 2002 (JP) 2002-359019

(51) Int. Cl. G11B 7/00

(52) U.S. Cl. 369/118; 369/121

(57) ABSTRACT

An optical head device includes a laser beam emitting element having a rectangular type body frame in which a semiconductor laser chip is accommodated, a light-emitting element holder having a first holder member and a second holder member, and a base portion to which the light-emitting element holder is mounted. The first holder member and the second holder member are fixed to each other so as to respectively about within part of the laser beam emitting element from both sides to hold the laser beam emitting element.

### BACKGROUND OF THE INVENTION

1. Field of the Invention

The present invention relates to an optical head device used for the reproduction of data from an optical recording medium such as an optical recording disk, i.e., a CD or a DVD. More specifically, the present invention relates to a mounting technique for mounting a laser beam emitting element of a frame type to a base portion in an optical head device.

2. Description of Related Art

An optical head device used for the reproduction of data from an optical recording disk such as a CD or a DVD includes a laser beam emitting element, an objective lens drive mechanism which is provided with an objective lens that converges the laser beam emitted from the laser beam emitting element on an optical recording medium and is driven in a focusing direction and a tracking direction, a light receiving element which receives the return light reflected by the optical recording disk, and optical components which are disposed to guide the laser beam between the laser beam emitting element and the light receiving element. These optical components are mounted on a base portion of the optical head device.

The laser beam emitting element conventionally used is a can type which is constituted in such a manner that a semiconductor laser chip is accommodated in a cylindrical case. In order to mount the laser beam emitting element of such a can type on the base portion of the optical head device, the laser beam emitting element is press-fitted and fixed to a light-emitting element holder with a hole in a circular shape and then the light-emitting element holder is adhered and fixed to the base portion.

Also, there is a laser beam emitting element of a frame type which is constituted in such a manner that a semiconductor laser chip is accommodated in a rectangular type frame. However, the laser beam emitting element of such a frame type is very difficult to be mounted to the base portion of the optical head device via the light-emitting element holder to which the laser beam emitting element is press-fitted.

In other words, the laser beam emitting element of a can type with a cylindrical outer shape is easy to press-fit into a circular hole of the light-emitting element holder. However, in the case of the laser beam emitting element of a frame type, when the frame with an outer shape of a rectangular type is press-fitted into a rectangular cross-sectional hole of the light-emitting element holder, an excessive force is liable to be applied to the frame. Besides, since the frame of the laser beam emitting element of the frame type is formed of a thin plate, when the frame is forcibly press-fitted to the holder, there is a possibility of the frame deforming. Such a deformation may cause to lower the degree of the mounting precision of the laser beam emitting element with respect to the light-emitting element holder.

Further, the rectangular cross-sectional hole of the light-emitting element holder to which the laser beam emitting element is press-fitted should be formed in a slit hole shape which is deep and narrow. It is extremely difficult to manufacture a molding die having such a slit hole and to provide the light-emitting element holder using a molding die.

### SUMMARY OF THE INVENTION

In view of the problems described above, it is advantage of the present invention to provide an optical head device which is capable of easily holding a laser beam emitting element of a frame type in a light-emitting element holder with a high degree of precision.

In order to achieve the above advantage, according to the present invention, there is provided an optical head device including a laser beam emitting element having a rectangular type body frame in which a semiconductor laser chip is accommodated, a light-emitting element holder that holds the laser beam emitting element and includes a first holder member and a second holder member, and a base portion to which the light-emitting element holder is mounted. The first holder member and the second holder member are fixed to each other so as to respectively abut with a part of the laser beam emitting element from both sides to hold the laser beam emitting element.

According to the optical head device having such a constitution, the first holder member and the second holder member are fixed so as to respectively abutted with one portion of the laser beam emitting element from both sides to hold the laser beam emitting element. Therefore, without using the press fitting constitution, the laser beam emitting element can be easily and naturally held with the light-emitting element holder. In addition, since the press fitting constitution is not employed, an excessive force is not exerted on the rectangular body frame of the laser beam emitting element and thus the body frame of the laser beam emitting element will not deform. Accordingly, the degree of precision in attaching the laser beam emitting element such as its position or its direction is not lowered.

Further, the light-emitting element holder is not required to be formed with a slit that is deep and narrow to press-fit the laser beam emitting element. Therefore, a molding die for forming the light-emitting element holder can be easily manufactured and thus the light-emitting element holder can be produced by using the molding die.

In accordance with an embodiment of the present invention, the laser beam emitting element is provided with protrusion plate parts, preferably fins for heat radiation, which are formed so as to be protruded sideward from the body frame of the laser beam emitting element. The first holder member and the second holder member respectively abut with the protrusion plate parts or the fins from both sides to hold the laser beam emitting element by the light-emitting element holder. In this case, it is preferable that the body frame of the laser beam emitting element is held so as not to be directly pressed by the light-emitting element holder. That is, the body frame of the laser beam emitting element is held in a non-contact state with the light-emitting element holder. According to the optical head device having such a constitution, a force by the light-emitting element holder is not applied to the thin plate forming the body frame and thus the body frame will not deform. Accordingly, the degree of precision in attaching the laser beam emitting element with respect to the light-emitting element holder is not lowered.

According to an embodiment of the present invention, when the first holder member and the second holder member are connected to each other, an attaching face of the light-emitting element holder to the base portion of the optical head device is formed. The attaching face is provided with an opening portion through which the laser beam emitted from the laser beam emitting element is passed.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a schematic configuration view showing an optical system of an optical head device in accordance with an embodiment of the present invention.

FIG. 2(a) is a front view showing a laser beam emitting element of a frame type which is mounted on a light-emitting element holder, FIG. 2(b) is its bottom view, FIG. 2(c) is its rear view, and FIG. 2(d) is its right side view.

FIG. 3(a) is an exploded perspective view showing a state before a first holder member and a second holder member of the light-emitting element holder shown in FIGS. 2(a)-(d) are attached to each other. FIG. 3(b) is a perspective view showing a state after the first holder member and the second holder member are attached to each other.

FIG. 4 is a partially sectional view showing the light-emitting element holder shown in FIGS. 2(a)-(d) and 3(a)-(b) and is mounted to a base portion of the optical head device.

FIG. 5(a) is a front view showing a laser beam emitting element of a frame type which is mounted on a light-emitting element holder in an optical head device in accordance with another embodiment of the present invention, FIG. 5(b) is its bottom view, FIG. 5(c) is its rear view, FIG. 5(d) is its right side view, and FIG. 5(e) is its left side view.

FIG. 6(a) is an exploded perspective view showing a state before a first holder member and a second holder member of the light-emitting element holder shown in FIGS. 5(a)-(e) are attached to each other. FIG. 6(b) is an exploded perspective view showing a state before the first holder member and the second holder member are attached to each other, which is viewed at another angle different from that in FIG. 6(a). FIG. 6(c) is a perspective view showing a state that the first holder member and the second holder member are attached to each other.

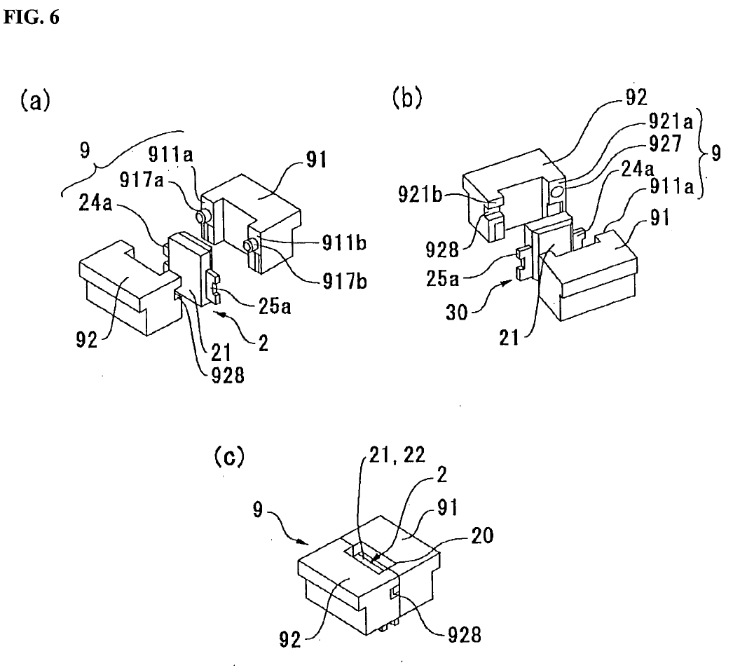

### DETAILED DESCRIPTION OF THE PREFERRED EMBODIMENTS

An optical head device in accordance with an embodiment of the present invention will be described below with reference to the accompanying drawings.

Entire Constitution

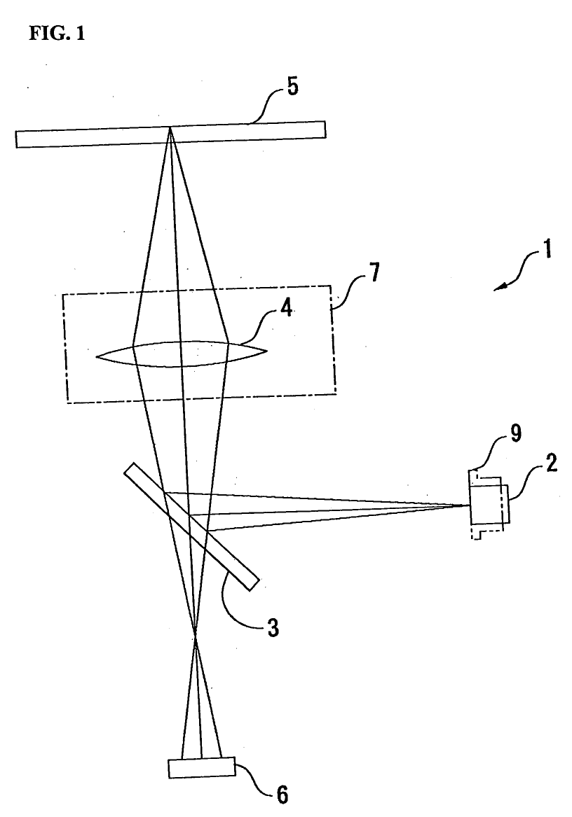

FIG. 1 is a schematic configuration view showing an example of an optical head device to which the present invention is applied.

As shown in FIG. 1, the optical head device 1 performs recording or reproducing data on or from an optical record disk 5 (optical recording medium) such as a CD or a DVD. The optical head device 1 includes a laser beam emitting element 2, a half mirror 3 that reflects a laser beam emitted from the laser beam emitting element 2 toward an optical recording medium 5, an objective lens 4 that converges the laser beam reflected by the half mirror 3 on the optical record disk 5, and a photo detector 6 receiving a return light that is reflected by the optical record disk 3 and passes through the objective lens 4 and the half mirror 3. These optical components are mounted on a base portion of the optical head device not shown in the drawing. The base portion is also provided with an objective lens drive mechanism 7, which is used to adjust the position of the objective lens 4 in a tracking direction and a focusing direction, or the like.

In the embodiment described above, the laser beam emitting element 2 is an element of a rectangular frame type in which a semiconductor laser chip is accommodated in a rectangular body frame and is mounted on a base portion of the optical head device by using a light-emitting element holder 9 described in detail below.

Constitution of Light-Emitting Element Holder

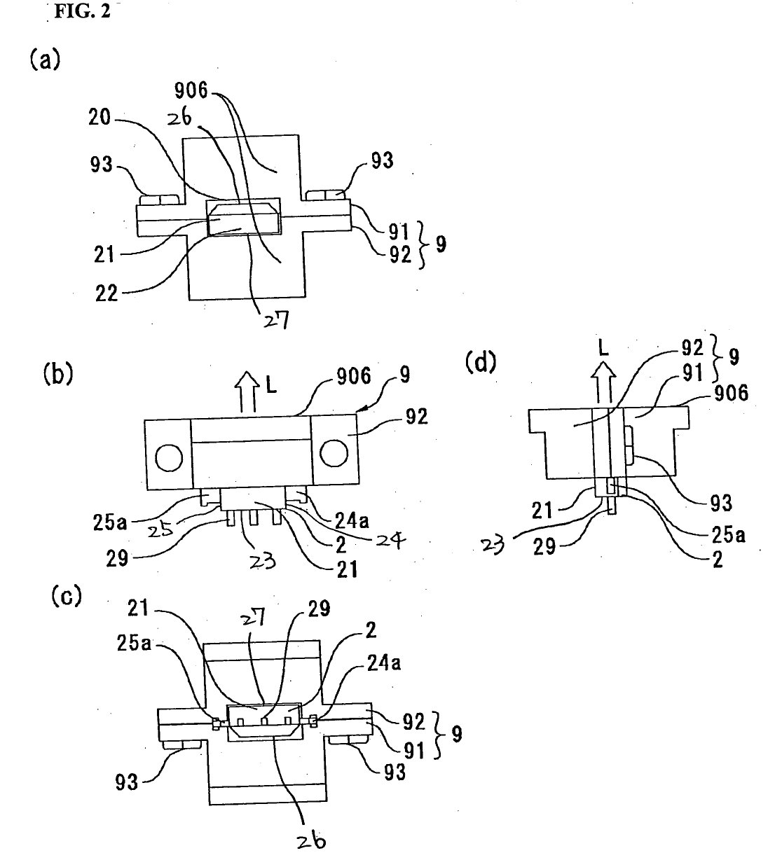

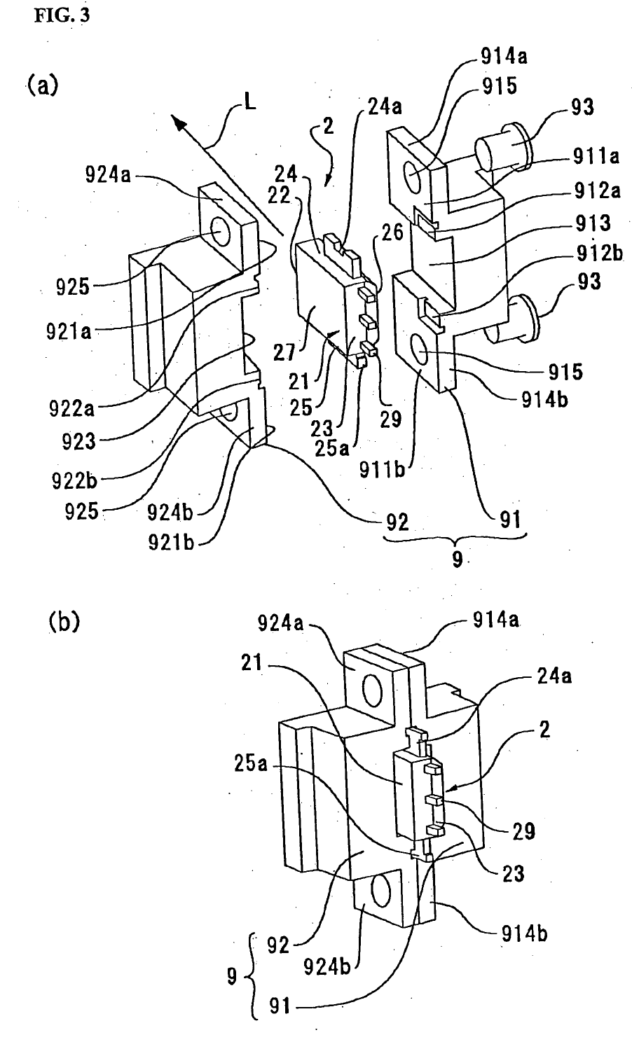

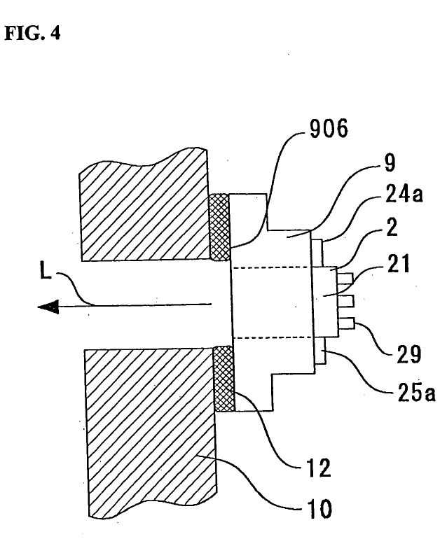

FIG. 2(a) is a front view showing a laser beam emitting element 2 of a rectangular frame type which is mounted on a light-emitting element holder 9, FIG. 2(b) is its bottom view, FIG. 2(c) is its rear view, and FIG. 2(d) is its right side view. FIG. 3(a) is an exploded perspective view showing a state before a first holder member and a second holder member constituting the light-emitting element holder 9 are attached to each other. FIG. 3(b) is a perspective view showing a state after the first holder member and the second holder member are attached to each other. FIG. 4 is a partially sectional view showing the light-emitting element holder shown in FIGS. 2(a)-(d) and 3(a)-(b) and is mounted to a base portion of the optical head device.

As shown in FIGS. 2(a)-(d) and 3(a)-(b), the laser beam emitting element 2 used in this embodiment is provided with a body frame 21 of a rectangular type. The body frame 21 includes an emission face 22 that emits the laser beam a back face 23 on the back side of the emission face 22 from which metal terminals 29 are protruded, a pair of fin formed faces 24 and 25, from which protruded plate parts, that is, heat radiation metal fins 24a and 25a in this embodiment, are protruded sideward, and a first and a second end surface 26 and 27. The protruded plate parts or the heat radiation metal fins 24a and 25a are formed so as to be protruded in parallel with the end surfaces 26 and 27.

When heat radiation is needed, the protruded plate parts which are protruded from the body frame 21 are preferably formed as the fins 24a, 25a by using a metal material excellent in heat radiation. Further, in this case, it is also preferable to use a metal material excellent in heat radiation for the first holder member and the second holder member. Alternatively, the protruded plate parts may be used only as the fixed parts to hold the laser beam emitting element 2 by the first holder member and the second holder member without using the fins 24a, 25a as for the heat radiation. In this case, the rectangular body frame 21 can be mounted to the light-emitting element holder without the thin plate of the rectangular body frame 21 being directly pressed by the light-emitting element holder.

The light-emitting element holder 9 includes a first holder member 91 and a second holder member 92. The first holder member 91 and the second holder member 92 are connected to each other so as to abut with at least a part of the laser beam emitting element 2 from both sides to hold the laser beam emitting element 2 by interposing it between them.

As shown in FIGS. 3(a)-(b), the first holder member 91 positioned on the first end surface 26 side of the body frame 21 includes stepped concave parts 912a and 912b, which are respectively formed on abutting faces 911a, 911b with the second holder member 92 so as to receive and hold the fins 24a, 25a of the laser beam emitting element 2. The first holder member 91 is also provided with a groove part 913 for accommodating the body frame 21 in a non-contact condition. The groove part 913 is formed with a depth and a width so as not to come into contact with any face of the body frame 21 when the fins 24a, 25a are interposed and abutted with the stepped parts 912a, 912b. In addition, the first holder member 91 is provided with a pair of flange parts 914a and 914b, each of which is formed with a through hole 915 for mounting a screw 93.

The second holder member 92 positioned on the second end surface 27 side of the body frame 21 includes stepped concave parts 922a and 922b, which are respectively formed on abutting faces 921a, 921b with the first holder member 91 so as to receive and hold portions of the fins 24a, 25a of the laser beam emitting element 2. The second holder member 92 is also provided with a groove part 923 for accommodating the body frame 21 in a non-contact condition. The groove part 923 is also formed with a depth and a width so as not to come into contact with any face of the body frame 21 when the fins 24a, 25a are interposed and abutted with the stepped parts 922a, 922b. In addition, the second holder member 92 is provided with a pair of flange parts 924a and 924b, and each of which is formed with a tapped hole 925 for fitting a screw 93.

Therefore, when the first and the second holder members 91, 92 are fixed together by the screw 93 so as to interpose the laser beam emitting element 2 between the first and the second holder members 91 and 92, the laser beam emitting element 2 is held by the first holder member 91 and the second holder member 92. Alternatively, the first and the second holder members 91 and 92 are loosely fastened by the screw 93 and the laser beam emitting element 2 is inserted into a space formed by the grooves 913 and 923. Then, when the screw 93 is firmly fastened, the laser beam emitting element 2 is held by the first holder member 91 and the second holder member 92 between them.

In this case, the end portions of the fins 24a and 25a of the laser beam emitting element 2 abut against the wall surfaces of the stepped concave parts 912a, 912b, 922a and 922b of the first and the second holder members 91 and 92. Therefore, the laser beam emitting element 2 is positioned by the wall surfaces of the stepped concave parts 912a, 912b, 922a and 922b, which serve as a stopper. In other words, the laser beam emitting element 2 is held by the first and the second holder members 91, 92 by means of that the fins 24a and 25a, which are the protruded plate parts, are held and fixed by the first and the second holder members 91, 92. In this state, the fins 24a and 25a are fitted between the stepped concave parts 912a, 912b of the first holder member 91 and the stepped concave parts 922a, 922b of the second holder member 92, and thus, the fins 24a and 25a are held by the first and the second holder members 91, 92 from both sides. The remaining portions of the fins 24a, 25a of the laser beam emitting element 2 are protruded from the light-emitting element holder 9.

In addition, as described above, the groove part 913 is formed with the depth and the width so as not to come into contact with the body frame 21 when the fins 24a, 25a are fixed by the stepped parts 912a, 912b, and the groove part 923 is also formed with the depth and the width so as not to come into contact with the body frame 21 when the fins 24a, 25a are fixed by the stepped parts 922a, 922b. Therefore, in this embodiment, the space formed between the grooves 913 and 923 is wider than the thickness and the width of the body frame 21 of the laser beam emitting element 2 under the state that the first holder member 91 is fixed to the second holder member 92. Accordingly, the light-emitting element holder 9 (the first and the second holder members 91, 92) holds the body frame 21 of the laser beam emitting element 2 in the non-contact state.

In the state that the laser beam emitting element 2 is mounted to the light-emitting element holder 9 as described above, an attaching face 906 for being attached to the base portion of the optical head device is formed by the light-emitting element holder 9 and at the same time an aperture 20 through which a laser beam emitted from the laser beam emitting element 2 passes is formed on the attaching face 906.

Therefore, the light-emitting element holder 9 provided with the laser beam emitting element 2 is fixed to the base portion 10 of the optical head device 1 by using an adhesive 12 as shown in FIG. 4 and then the laser beam emitting element 2 can be mounted to the base portion 10 via the light-emitting element holder 9. At this time, the position of the light-emitting element holder 9 may be adjusted in the three-dimensional direction and the alignment of the emitting point of the laser beam emitting element 2 is performed.

As described above, in the optical head device 1 in accordance with the embodiment of the present invention, the light-emitting element holder 9 includes the first holder member 91 and the second holder member 92 which respectively abut with at least part of the laser beam emitting element 2 from both sides to interpose the laser beam emitting element 2 between them. Therefore, without using the press fitting constitution, the laser beam emitting element 2 can be easily and naturally held in the light-emitting element holder 9. In addition, since the press fitting constitution is not employed, an excessive force is not exerted on the body frame 21 of the laser beam emitting element 2.

Moreover, the first holder member 91 and the second holder member 92 of the light-emitting element holder 9 abut with the fins 24a, 25a from both sides and thus the body frame 21 of the laser beam emitting element 2 is held in a non-contact state with the light-emitting element holder 9. Therefore, the light-emitting element holder 9 does not apply a force to the thin plate that forms the body frame 21 and thus the body frame 21 may not deform. Accordingly, the degree of the attaching precision of the laser beam emitting element 2 with respect to the light-emitting element holder 9 is not lowered.

Further, the light-emitting element holder 9 is not provided with a slit which is deep and narrow for press-fitting the laser beam emitting element 2. Therefore, a molding die for forming the light-emitting element holder 9 can be easily manufactured and thus the light-emitting element holder 9 can be produced by using a molding die.

### Other Embodiments

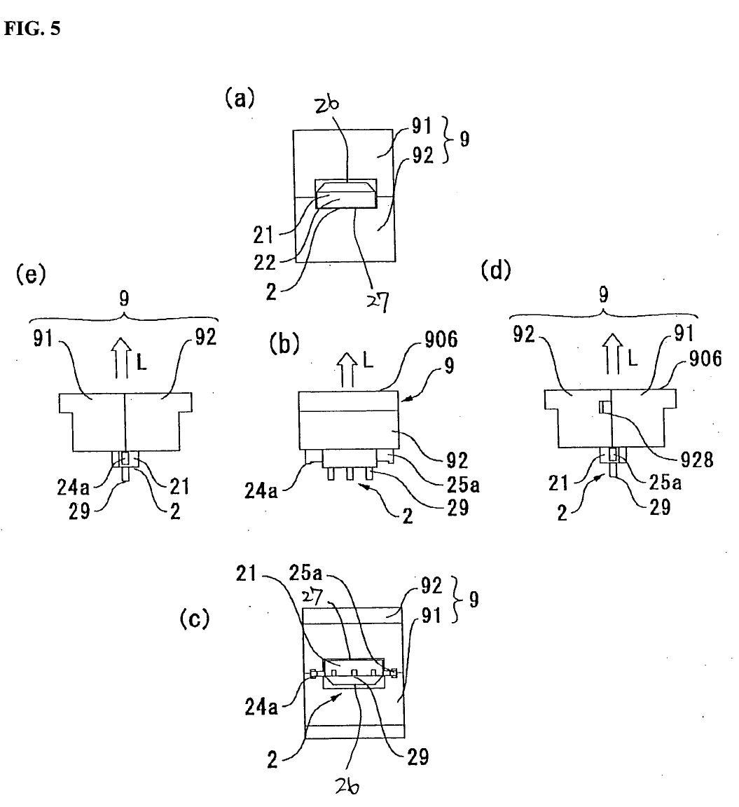

In the embodiment described above, the first and the second holder members 91 and 92 constituting the light-emitting element holder 9 are fixed by the screw 93. However, the first and the second holder members 91 and 92 may be connected to each other by using a boss which is formed on the abutting surface of one of the holder members 91 and 92, and a hole press-fitted by the boss, which is formed on the abutting surface of the other of the holder members 91 and 92. For example, as shown in FIGS. 5(a)-(e) and 6(a)-(c), it may be constituted in such a manner that bosses 917a and 917b for press fitting are formed on the abutting surfaces 911a, 911b of the first holder member 91. In this case, it may be modified that a hole 927 used for press fitting, to which the boss 917a is press fitted, is formed on the abutting surface 921a of the second holder member 91 and a groove 928 for press fitting, to which the boss 917b is press fitted, is formed on the abutting surface 921b. Other constitutions can be similarly adapted to this embodiment and therefore, the detail descriptions are omitted.

As described above, the optical head device according to the present invention includes the first holder member and the second holder member that are fixed to each other so as to respectively abut with the laser beam emitting element from both sides to hold the laser beam emitting element. Therefore, without using the press fitting constitution, the laser beam emitting element can be easily and naturally held in the light-emitting element holder. In addition, since the press fitting constitution is not employed, an excessive force is not exerted on the body frame of the laser beam emitting element. Accordingly, the degree of precision in attaching the laser beam emitting element with respect to the light-emitting element holder is not lowered.

Further, the light-emitting element holder is not formed with a slit which is deep and narrow for the press-fitting of the laser beam emitting element. Therefore, a molding die for forming the light-emitting element holder can be easily manufactured and thus the light-emitting element holder can be produced by using the molding die.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. An optical head device comprising:
a laser beam emitting element having a rectangular type body frame in which a semiconductor laser chip is accommodated;
a light-emitting element holder that holds the laser beam emitting element and includes a first holder member and a second holder member; and
a base portion to which the light-emitting element holder is mounted,
wherein the first holder member and the second holder member are fixed to each other so as to respectively abut with part of the laser beam emitting element from both sides to hold the laser beam emitting element.

2. The optical head device according to claim 1, further comprising protruded plate parts that protrude sideward from the rectangular type body frame of the laser beam emitting element and are held by the first holder member and the second holder member from both sides so that the rectangular type body frame is not pressed by the first holder member and the second holder member.

3. The optical head device according to claim 2, wherein the protruded plate parts are formed as a fin for heat radiation.

4. The optical head device according to claim 2, further comprising:
a groove part formed on an opposing surface of the first holder member to the second holder member;
a groove part formed on an opposing surface of the second holder member to the first holder member, and
a space that is formed by the groove part of the first holder member and the groove part of the second holder member for accommodating the rectangular type body frame of the laser beam emitting element,
wherein the space is formed larger than the rectangular type body frame.

5. The optical head device according to claim 1, further comprising:
an attaching face formed on the first holder member for attaching to the base portion;
an attaching face formed on the second holder member for attaching to the base portion, and
an aperture formed by the attaching faces of the first and the second holder members for passing the laser beam emitted by the laser beam emitting element through.

6. The optical head device according to claim 1, further comprising means for connecting the first holder member and the second holder member.

7. The optical head device according to claim 1, further comprising a screw that connects the first holder member and the second holder member.

8. The optical head device according to claim 1, further comprising a boss and a hole press-fitted by the boss that connect the first holder member and the second holder member.

9. The optical head device according to claim 1, wherein the body frame includes an emission face and a back face.

10. The optical head device according to claim 3, wherein the first holder member includes stepped concave parts formed on abutting faces with the second holder member to receive the protruded plate parts.

11. The optical head device according to claim 3, wherein the second holder member includes stepped concave parts formed on abutting faces with the first holder member to receive the protruded plate parts.

12. The optical head device according to claim 10, wherein the protruded plate parts abut against wall surfaces of the stepped concave parts of the first holder member.

13. The optical head device according to claim 11, wherein the protruded plate parts abut against wall surfaces of the stepped concave parts of the second holder member.

14. The optical head device according to claim 1, further comprising means for the attaching light-emitting element holder to the base portion.

15. An optical head device comprising:
a laser beam emitting element having a rectangular type body frame in which a semiconductor laser chip is accommodated;
a light-emitting element holder that holds the laser beam emitting element and includes a first holder member and a second holder member;
a base portion to which the light-emitting element holder is mounted; and
means for attaching the first holder member and the second holder member,
wherein the first holder member and the second holder member are fixed to each other so as to respectively abut with part of the laser beam emitting element from both sides to hold the laser beam emitting element.

16. A method for manufacturing an optical head device comprising:
accommodating a semiconductor laser chip in a laser beam emitting element having a rectangular type body frame;
holding the laser beam emitting element in a light-emitting element holder having a first holder member and a second holder member;
mounting the light-emitting element holder to a base portion; and
attaching the first holder member and the second holder member to each other so as to respectively abut with part of the laser beam emitting element from both sides to hold the laser beam emitting element.

17. The optical head device manufacturing method according to claim 16, further comprising securing protruded plate parts that protrude sideward from the rectangular type body frame of the laser beam emitting element to the first holder member and the second holder member from both sides so that the rectangular type body frame is not pressed by the first holder member and the second holder member.

18. The optical head device manufacturing method according to claim 17, further comprising forming the protruded plate parts as a fin for heat radiation.

19. The optical head device manufacturing method according to claim 17, further comprising:
forming a groove part on an opposing surface of the first holder member to the second holder member;
forming a groove part on an opposing surface of the second holder member to the first holder member; and
accommodating the rectangular type body frame of the laser beam emitting element in a space that is formed by the groove part of the first holder member and the groove part of the second holder member with the space formed larger than the rectangular type body frame.

20. The optical head device manufacturing method according to claim 16, further comprising:
forming an attaching face on the first holder member for attaching to the base portion;
forming an attaching face on the second holder member for attaching to the base portion; and
passing the laser beam emitted by the laser beam emitting element through an aperture formed by the attaching faces of the first and the second holder members.
